(19) United States
(12) Patent Application Publication
(10) Pub. No.: US 2005/0094220 A1
(43) Pub. Date: May 5, 2005

(54) Scanner

(75) Inventor: Tsung-Te Lin, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/970,572

(22) Filed: Oct. 21, 2004

(30) Foreign Application Priority Data
Oct. 30, 2003 (TW) TW92219265

(51) Int. Cl. H04N 1/40

(52) U.S. Cl. 358/474; 358/494

(57) ABSTRACT

A scanner for scanning an object. The scanner comprises a platen, a scanning device, a resilient member and a sliding member. The object is placed on the platen. The scanning device scans the object. The sliding member is pivoted on the scanning device and slidably connects the resilient member pushing the scanning device toward the platen.

### BACKGROUND OF THE INVENTION

1. Field of the Invention

The present inventions relates to a scanner and in particular to a scanner with a contact image sensor (CIS).

2. Description of the Related Art

FIG. 1a shows a conventional contact image sensor (CIS) scanner, which includes an upper frame 11, a lower frame 12, a platen 13, a scan head 14, a track 15 and a driving mechanism 16. The upper frame 11 has an opening 111 therein in which the platen 13 is disposed. The scan head 14 is disposed between the upper frame 11 and the lower frame 12. A contact image sensor (not shown) is recessed in the scan head 14. The contact image sensor scans the object placed on the platen 13. The track 15 is disposed in the lower frame 12. The scan head 14 has a connecting portion 141 connected to the track 15. The driving mechanism 16 moves the scan head 14 along the track 15 to complete a scan of the object.

FIG. 1b shows the structure of the scanner shown in FIG. 1a. In FIG. 1b, the connecting portion 141 is formed at the bottom of the scan head 14. Several rollers 142 are installed at the top of the scan head 14 to contact the platen 13. Meanwhile, the scan head 14 is connected to the driving mechanism 16 by a belt 161, moving the scan head 14 along the track 15.

It may be difficult to maintain a predetermined distance between the object and the contact image sensor. Any fluctuation in mechanical dimension or change in temperature can cause deformation in material and render mass production difficult.

### SUMMARY OF THE INVENTION

Therefore, an object of the present invention is to disclose a scanner that solves the above mentioned problem.

The scanner for scanning an object comprises a platen, a scanning device, a resilient member and a sliding member. The object is placed on the platen. The scanning device scans the object. The sliding member is pivoted on the scanning device and slidably connects the resilient member pushing the scanning device toward the platen.

The scanning device may comprise a sensor and a carriage. The sensor is recessed in the carriage to scan the object, and the scanning device is movably disposed under the platen.

The carriage may comprise a contacting element contacting the platen. The contacting element may comprise a material with low reaction coefficient or a lubricating element.

The carriage may comprise a pivot and the sliding member may comprise an opening. The pivot passes through the opening to connect the sliding member to the carriage.

The sliding member may further comprise a recess receiving the resilient member.

The resilient member may be rectangular and the recess may comprise two flanges. The flanges clip two sides of the resilient member.

The sensor may be a contact image sensor (CIS).

The sliding member may comprise a flat body, two protrusions and two flanges. The protrusions extend from two sides of the flat body, and the flanges extend from two sides of the flat body opposite to the protrusions.

Each protrusion may comprise an opening and the scanning device may comprise a pivot. The pivot passes through the opening to connect the sliding member to the scanning device.

The scanner may further comprise a driving mechanism connecting the scanning device, driving the scanning device moving along the resilient member to scan the object.

The resilient member may comprise a resilient belt.

### DESCRIPTION OF THE DRAWINGS

The present invention can be more fully understood by reading the subsequent detailed description in conjunction with the examples and references made to the accompanying drawings, wherein:

FIG. 1a is a schematic diagram of a conventional scanner;

FIG. 1b is an enlarged view of the scanner;

FIG. 2 is a schematic diagram of a scanner of the present invention;

FIG. 3a is an enlarged view of the scanner of the present invention before assembling the platen;

FIG. 3b is an enlarged view of the scanner of the present invention after assembling the platen; and

FIG. 3c is a local enlarged view of the present invention.

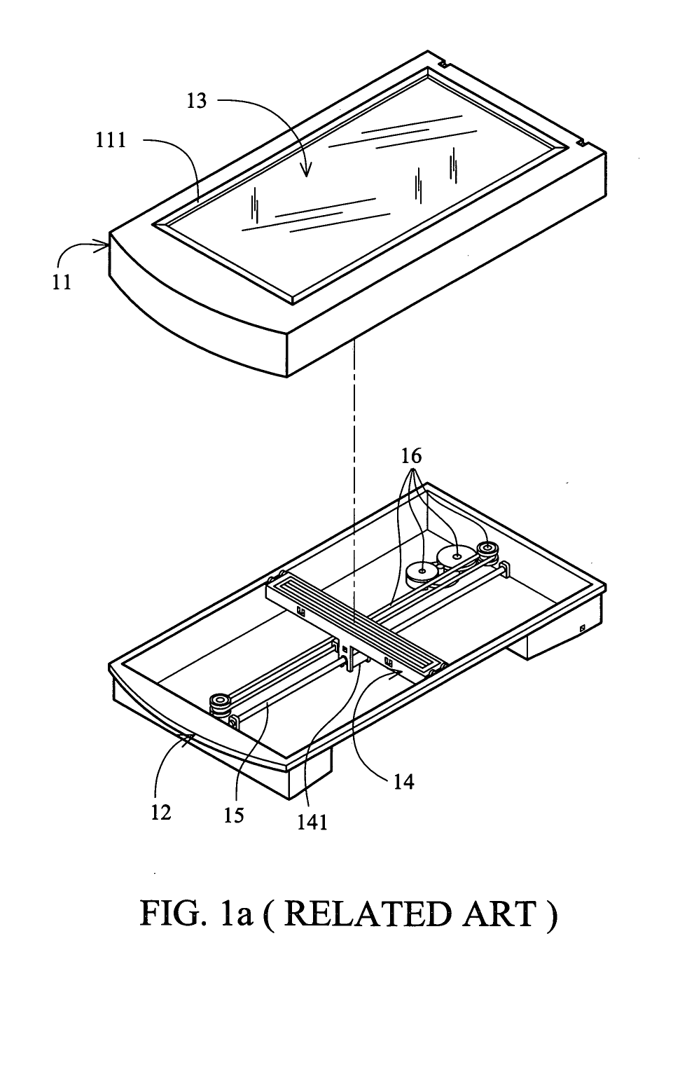

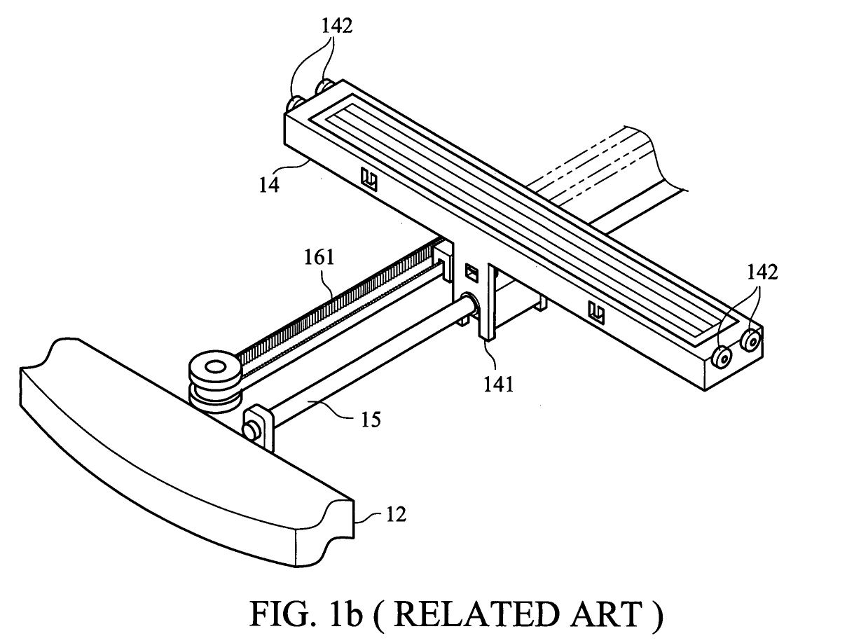

### DETAILED DESCRIPTION OF THE INVENTION

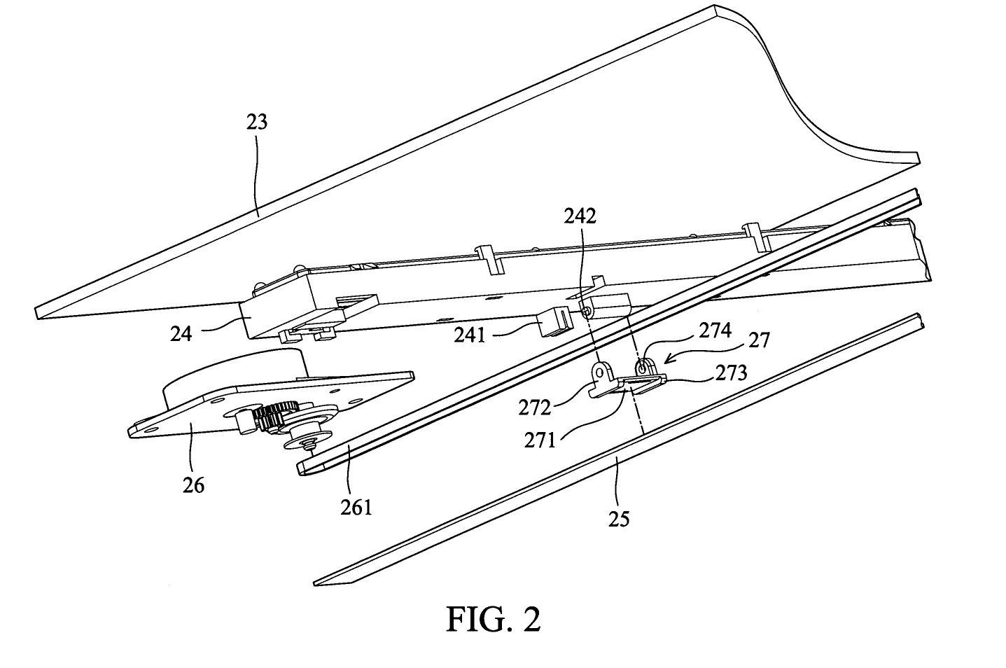

FIG. 2 shows a scanner of the present invention. Description of the scanner having devices and elements contained in a shield as in a conventional scanner is omitted. The scanner of the present invention comprises a platen 23, a scanning device, a resilient member 25, and a sliding member 27. In this embodiment, the scanning device comprises a carriage 24 and a sensor (not shown). The sensor can be a contact image sensor (CIS).

An object such as a document or a picture is placed on the platen 23, and the platen is transparent. The carriage 24 is disposed under the platen 23 and the sensor is received therein. The sensor scans the object via the platen 23. The bottom of the carriage 24 has a connecting portion 241 and a pivot 242. A belt 261 of a driving mechanism 26 is connected to the connecting portion 241 of the carriage 24 so that the driving mechanism 26 moves the carriage 24. The sliding member 27 has a flat body 271, two protrusions 272 and two flanges 273. The protrusions 272 extend from two sides of the flat body 271, and the flanges 273 also extend from the two sides of the flat body 271 opposite to the protrusions 272. Each protrusion 272 has an opening 274 with the pivot 242 of the carriage 24 passing there through pivoting the sliding member 27 on the carriage 24. In this embodiment, the resilient member 25 is rectangular. Namely, the resilient member 25 is a resilient belt. The two flanges 273 of the sliding member 27 clip the side edges of the resilient member 25.

After assembling the scanner, the sliding member 27 pushes the carriage 24 toward the platen 23 by virtue of a resilient force of the resilient member 25. Therefore, a predetermined distance is maintained between the sensor in the carriage 24 and the object so that the object is secured on the focus of the sensor. Meanwhile, the driving mechanism 26 moves the carriage 24 along the resilient member 25 completing the scanning process.

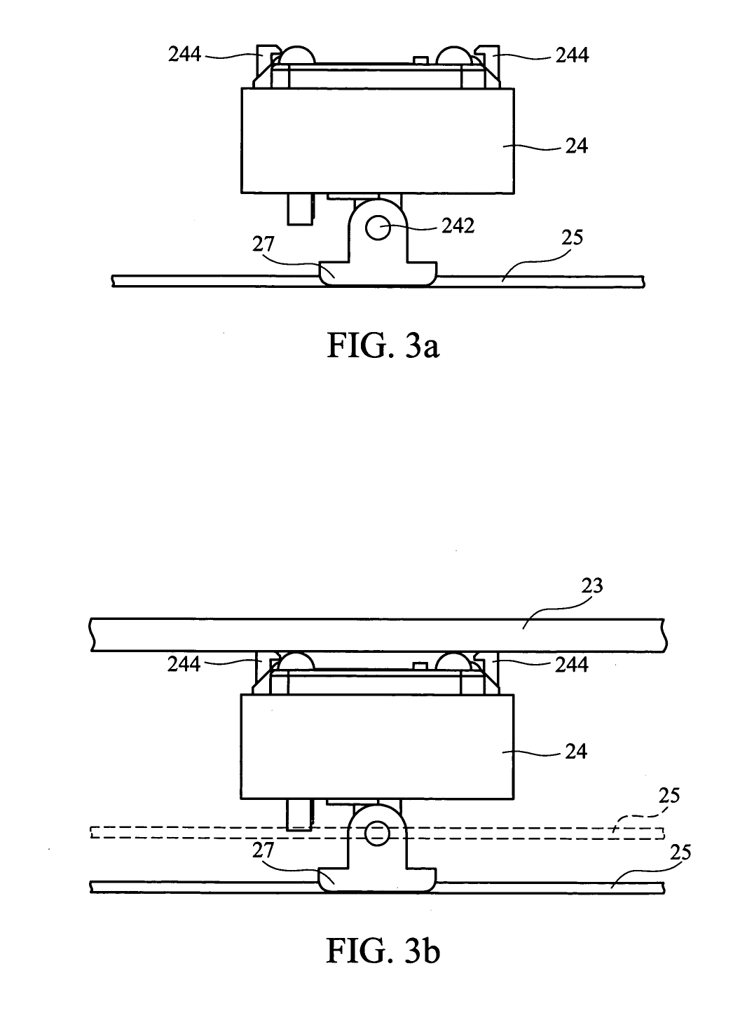

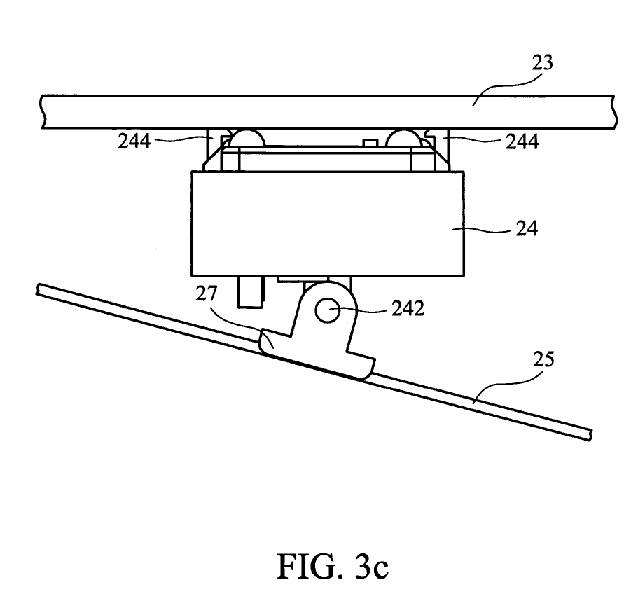

FIG. 3a shows a schematic diagram of the carriage 24 connected to the resilient member 25, here, the platen 23 is not assembled and the resilient member 25 is not yet deformed. The top of the carriage 24 is higher than the predetermined assembled position of the platen 23. Contacting elements 244 are disposed on the carriage 24 contacting the platen 23. The contacting element 244 may comprise a material with low reaction coefficient or a lubricating element. FIG. 3b shows a schematic diagram after the platen 23 is assembled. The carriage 24 is pushed downward by the platen 23 and the resilient member 25 changed from the dotted line to the solid line as shown in FIG. 3b. Namely, the resilient member 25 deformed by the platen 23 pushes downward so that the resilient member 25 generates a restoring force. The carriage 24 is pushed toward the platen by the restoring force. FIG. 3c shows a schematic diagram of the present invention after assembly. The platen 23 and the resilient member 25 are not parallel to each other. The pivot 242 of the carriage 24 passes through the opening 274 of the sliding member 27 so that the sliding member 27 is pivoted on the carriage 24, and the sliding member 27 is then connected to the resilient member 25. Thus, the carriage 24 makes parallel contact with the platen 23 by the restoring force of the resilient member 25. Namely, the scanner of the present invention secures the carriage 24 contacting the platen 23 during the scanning process so as to maintain the object in the focus of the sensor to secure the optical quality. Furthermore, the carriage 24 moves along the resilient member 25 by the driving mechanism 26, completing the scanning process.

Finally, while the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A scanner for scanning an object, comprising:
a platen with the object placed thereon;
a scanning device for scanning the object;
a resilient member; and
a sliding member, pivoted on the scanning device and slidably connected to the resilient member, pushing the scanning device toward the platen by virtue of a resilient force of the resilient member.

2. The scanner as claimed in claim 1, wherein the scanning device comprises a sensor and a carriage, and the sensor for scanning the object is disposed in the carriage to move under the platen.

3. The scanner as claimed in claim 2, wherein the carriage comprises a contacting element contacting the platen.

4. The scanner as claimed in claim 3, wherein the contacting element comprises a material with low reaction coefficient or a lubricating element.

5. The scanner as claimed in claim 2, wherein the carriage comprises a pivot and the sliding member comprises an opening, and the pivot passes through the opening to connect the sliding member to the carriage.

6. The scanner as claimed in claim 5, wherein the sliding member further comprises a recess for containing the resilient member.

7. The scanner as claimed in claim 6, wherein the resilient member is in a shape of rectangular and the recess comprises two flanges, and the flanges clip two sides of the resilient member.

8. The scanner as claimed in claim 2, wherein the sensor is a contact image sensor (CIS).

9. The scanner as claimed in claim 1, wherein the sliding member comprises a flat body, two protrusions and two flanges, the protrusions extending from two sides of the flat body, and the flanges extending from two sides of the flat body opposite to the protrusions.

10. The scanner as claimed in claim 9, wherein each protrusion comprises an opening, and the scanning device comprises a pivot, the pivot passing through the opening to connect the sliding member to the scanning device.

11. The scanner as claimed in claim 1, further comprising a driving mechanism connecting and driving the scanning device along the resilient member to scan the object.

12. The scanner as claimed in claim 1, wherein the resilient member is in a shape of rectangular.
